(19) United States
(12) Patent Application Publication
(10) Pub. No.: US 2001/0031806 A1
(43) Pub. Date: Oct. 18, 2001

(54) Use of mixtures of optical brighteners for improving the washfastness of brightened textiles

(76) Inventors: Thomas Lutkenhorst, Hochheim (DE); Thomas Martini, Kelkheim-Fischbach (DE); Joseph Thomas Craddock, Charlotte, NC (US)

Correspondence Address: CLARIANT CORPORATION, 4331 CHESAPEAKE DR, ATTN: INDUSTRIAL PROPERTY DEPT, CHARLOTTE, NC, 28216, US

(21) Appl. No.: 09/782,463

(22) Filed: Feb. 8, 2001

(30) Foreign Application Priority Data
Feb. 9, 2000 (DE) 10005595.8

(51) Int. Cl. C08K 5/34; C08J 3/00

(52) U.S. Cl. 524/106; 524/158

(57) ABSTRACT

An optical brightener mixture comprising

A) at least one anionic brightener selected from the group consisting of derivatives of pyrazoline that bear sulfonic acid or sulfonate groups and such anionic brighteners as are reproduced in formulae 1 to 12, and

B) at least one anionic brightener comprising a stilbene derivative that bears a sulfonic acid or sulfonate group on each of the two phenyl groups of stilbene and is substituted by a nitrogenous aromatic heterocycle at each of the two phenyl groups of stilbene

is used for preparing brightened polyamide and/or polyurethane fibers possessing improved washfastness for the optical brightening.

### BACKGROUND OF THE INVENTION

This invention relates to the use of optical brighteners for improving the washfastness of brightened textiles.

The fastness profile for optically brightened textile articles composed of polyamide and polyamide-polyurethane blends includes not just high requirements with regard to light- and weatherfastnesses but also high demands with regard to wash durabilities.

Brightened articles such as, for example, swimwear or underwear should lose very little white during washing even after multiple washes. These requirements are met primarily by those polyamide (PA) or polyamide-polyurethane (PU) materials where the brightener is applied during polymer making or by means of masterbatch technology. The brighteners used here generally have a high fastness profile.

However, to obtain top white effects and meet the changing fashions with regard to the tint, it is customary to employ textile application processes, for example exhaust processes, pad-thermosol processes, pad-steam or pad-wash processes or acid shock processes with and without reducing agents. These processes are known to those of ordinary skill in the art and can be reviewed in pertinent literature references (eg. R. Williamson, Fluorescent Brightening Agents in Textile Science and Technology p. 63-69, Elsevier Scientific Publishing Company, Amsterdam, Oxford, N.Y., 1980).

The brighteners applied by textile application methods have the disadvantage (to an extent corresponding to their different affinities for fiber) of being to some extent washed off again during subsequent laundering operations.

### SUMMARY OF THE INVENTION

It has now been found that, surprisingly, the washfastness of optical brighteners on polyamide and polyamide-polyurethane articles can be substantially improved by using mixtures of certain optical brighteners.

### DESCRIPTION OF THE PREFERRED EMBODIMENTS

The present invention accordingly provides for the use of an optical brightener mixture comprising

A) at least one anionic brightener selected from the group consisting of derivatives of pyrazoline that bear sulfonic acid or sulfonate groups and such anionic brighteners as are reproduced in formulae 1 to 12, and

B) at least one anionic brightener comprising a stilbene derivative that bears a sulfonic acid or sulfonate group on each of the two phenyl groups of stilbene and is substituted by a nitrogenous aromatic heterocycle at each of the two phenyl groups of stilbene

for preparing brightened polyamide and/or polyurethane fibers possessing an improved washfastness for the optical brightening.

It has been determined in this connection that even small quantities of constituent B), preferably 25% by weight or less, based on total brightener weight, in the mixture are sufficient to obtain a washfastness improvement for the white effects due to constituent A).

The brightener mixture is applied in accordance with the prior art; by the exhaust process in the present case.

Useful textile material includes any structures comprising polyamide or polyamide-polyurethane blends, the blend ratio being immaterial.

An exact definition of the chemical constitution of the fibers may be found in “Winnacker-Kuchler”, Chemische Technologie, Volume 6, Organische Technologie p. 690-700, and also p. 710. Karl Hanser Verlag Munich Vienna 1982.

The brightener quantities used are not critical and are in line with the recommendations of the technical bulletins of brightener manufacturers.

Constituent A) of the brightener mixture is preferably a pyrazoline derivative bearing substituents having sulfonic acid or sulfonate groups. These substituents are preferably aromatic substituents bearing halogen or alkyl radicals. The alkyl radicals may contain heteroatoms. The sulfonic acid or sulfonate groups are present either on the aromatic substituents or on the alkyl radicals. Aromatic substituents for the present purposes are in particular phenyl, naphthyl, biphenyl and anthracenyl.

The compounds of the formulae 1 to 15 are the following:

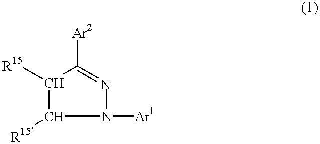

where Ar¹ and Ar² independently are sulfonated and further substituted or unsubstituted aryl radicals, especially sulfonated phenyl, biphenyl or naphthyl radicals, which may bear further substituents such as hydroxyl, (C₁-C₆)-alkyl, (C₁-C₆)-alkoxy, halogen, hydroxyalkyl, amino, alkylamino, acylamino, carboxyl, alkoxycarbonyl, sulfonic ester, alkylsulfonyl, aryisulfonyl, sulfonyl and sulfonamide groups, and R¹⁵ and R¹⁵, which may be identical or different, are each hydrogen, (C₁-C₄)-alkyl or phenyl.

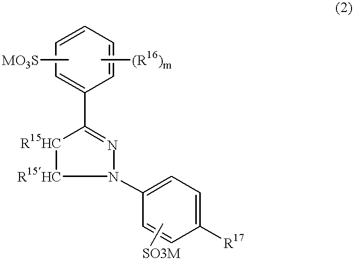

where R¹⁶ is halogen or (C₁-C₆)-alkyl, R¹⁷ is a substituted or unsubstituted (C₁-C₆)-alkoxycarbonyl, (C₁-C₆)-alkylsulfonyl, sulfonamide or sulfonic acid group, and m is zero, 1, 2 or 3.

Preferred pyrazoline brighteners are depicted in the formulae (3) to (5):

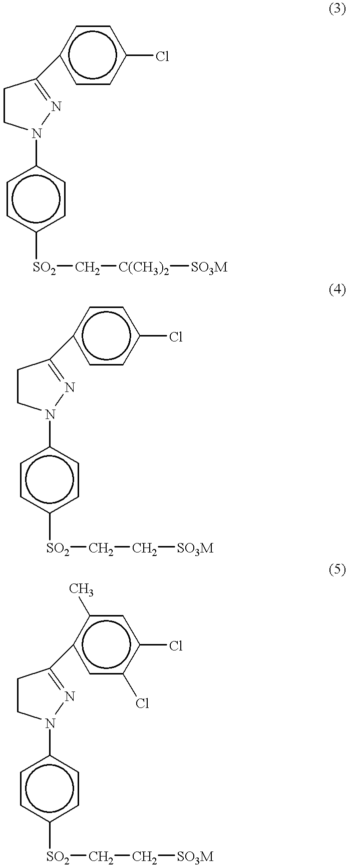

Further preferred optical brighteners for use as constituent A of the mixture are the following:

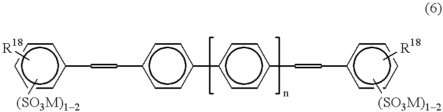

where R¹⁸=H, alkyl, oxalkyl, halogen, CN, COO-(C₁-C₄)-alkyl or CO-N[(C₁-C₄)alkyl]₂, and n=0, 1.

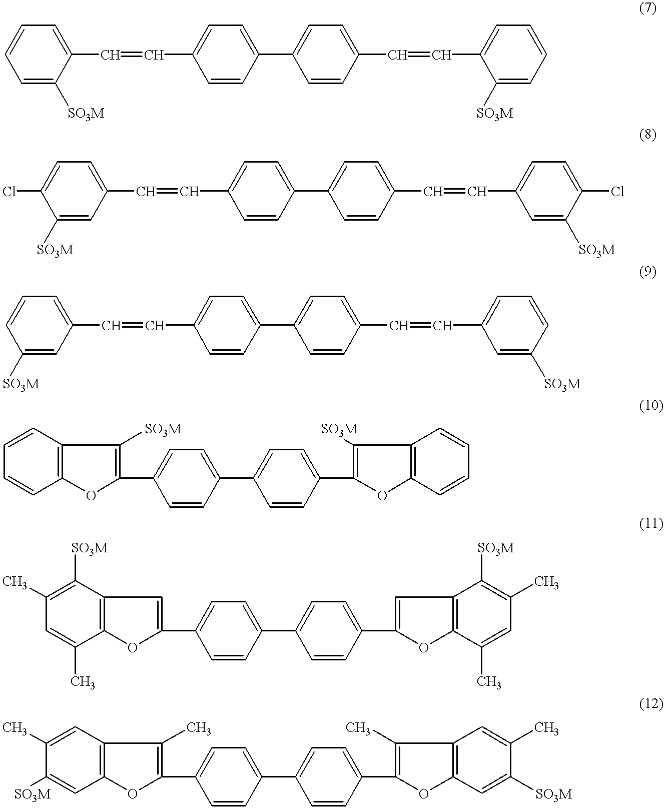

Constituent B of the mixture of optical brighteners is a stilbene derivative which generally conforms to the formula (13):

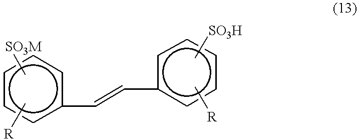

where R is an aromatic nitrogenous heterocycle. This heterocycle is preferably derived from triazole or triazine. Particularly preferred compounds for constituent B are:

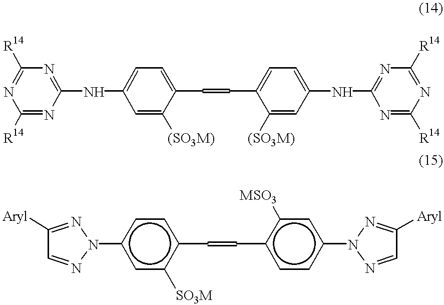

### EXAMPLES

Examples

%ages are by weight, unless otherwise stated.

### Example 1

### Recipe for brightening woven PA6 by exhaust process

1 g/l of Sandoclean® PCJ liq. (nonionic washing and wetting agent)

1% of commercially available optical brighteners or brightener mixture of formulae 16 to 21 based on weight of fiber

pH 4 (acetic acid)

98° C./40 min

Liquor ratio 10:1

Formula structures of employed optical brighteners 16 to 21

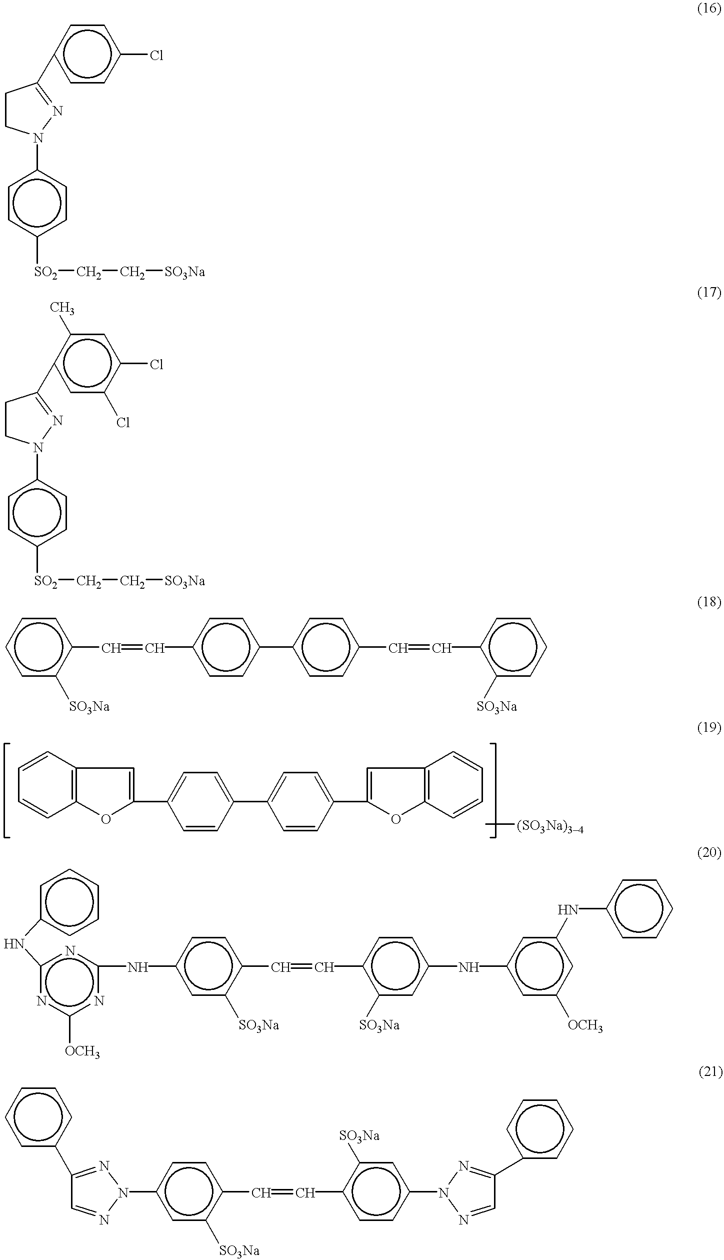

Results

The following Ganz whitenesses are obtained (commercially available brighteners)

1% of brightener of formula 16 (about 13% active) 230

1% of brightener of formula 17 (about 13% active) 227

1% of brightener of formula 18 (about 20% active) 233

1% of brightener of formula 19 (about 15% active) 226 (lab formulation)

1% of brightener of formula 20 (about 20% active) 221

1% of brightener of formula 21 (about 12% active) 222

### Example 2

The fabric samples brightened according to Example 1 are washed five times according to the following recipe and the white effects are determined after every wash:

Liquor ratio 20:1

1% of H₂O₂ 35% based on weight of fiber

5 g/l of commercially available brightener-free laundry detergent

55° C./30 min

This is followed by a cold rinse.

Results of Example 2

| | Ganz whitenesses | | | | |
|---|---|---|---|---|---|
| Brightener | 1st wash | 2nd wash | 3rd wash | 4th wash | 5th wash |
| 16 | 203 | 176 | 144 | 121 | 109 |
| 17 | 215 | 206 | 189 | 175 | 166 |
| 18 | 226 | 225 | 218 | 212 | 207 |
| 19 | 224 | 216 | 210 | 202 | 193 |
| 20 | 225 | 227 | 227 | 227 | 228 |
| 21 | 221 | 224 | 223 | 220 | 224 |

### Example 3

0.8% of the brightener of formula 16 and 0.2% of the brightener of formula 20 are used for brightening as described under Example 1. The whiteness obtained is 230. After 5 washes according to Example 2, the whiteness is 213, a substantial improvement over the white effects on using brightener 16 alone.

### Example 4

0.8% of the brightener of formula 17 and 0.2% of the brightener of formula 20 are used for brightening as described under Example 1. The whiteness obtained is 223. After 5 washes according to Example 2, the whiteness is 214, a substantial improvement over the white effects on using brightener 17 alone.

### Example 5

0.8% of the brightener of formula 18 and 0.2% of the brightener of formula 20 are used for brightening as described under Example 1. The whiteness obtained is 233. After 5 washes according to Example 2, the whiteness is 220, a substantial improvement over the white effects on using brightener 18 alone.

### Example 6

0.9% of the brightener of formula 19 and 0.1% of the brightener of formula 20 are used for brightening as described under Example 1. The whiteness obtained is 223. After 5 washes according to Example 2, the whiteness is 201, a substantial improvement over the white effects on using brightener 19 alone.

### Example 7

0.8% of the brightener of formula 16 and 0.2% of the brightener of formula 21 are used for brightening as described under Example 1. The whiteness obtained is 229.

After five washes according to Example 2, the whiteness is 195, a substantial improvement over the white effects of Example 2 on using brightener 16 alone.

### Example 8

0.5% of the brightener of formula 16, 0.25% of the brightener of formula 20 and 0.25% of the brightener of formula 18 are used for brightening as described under Example 1.

The whiteness obtained is 226. After five washes according to Example 2, the whiteness is 216.

1. The method of using an optical brightener mixture comprising
A) at least one anionic brightener selected from the group consisting of derivatives of pyrazoline that bear sulfonic acid or sulfonate groups and such anionic brighteners as are reproduced in formulae 1 to 12, and
B) at least one anionic brightener comprising a stilbene derivative that bears a sulfonic acid or sulfonate group on each of the two phenyl groups of stilbene and is substituted by a nitrogenous aromatic heterocycle at each of the two phenyl groups of stilbene
for preparing brightened polyamide and/or polyurethane fibers possessing an improved washfastness for the optical brightening.

2. The method of claim 1, wherein constituent A) is a pyrazoline derivative bearing substituents having sulfonic acid or sulfonate groups, these substituents being aromatic groups bearing halogen, alkyl or heteroalkyl radicals.

3. The method of claim 2, wherein constituent A) is selected from said formulae 3 to 5

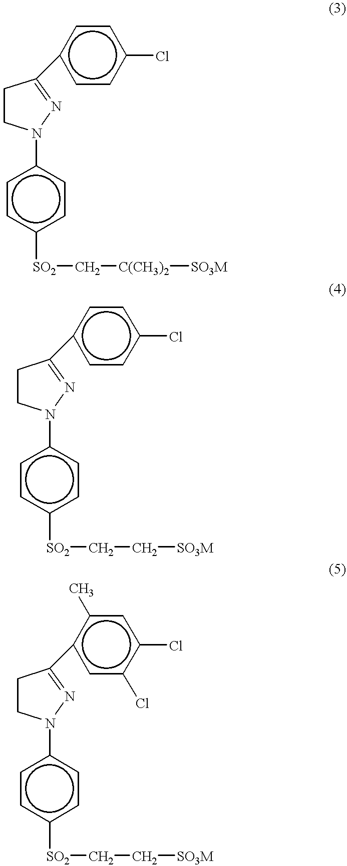

4. The method of claim 1, wherein constituent B is a stilbene derivative of formula 13 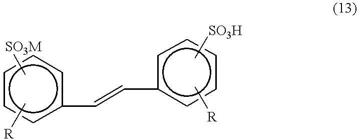
where R is a substituent derived from triazole or triazine.

5. The method of claim 4, wherein constituent B) is a compound selected from formula (14) or (15)

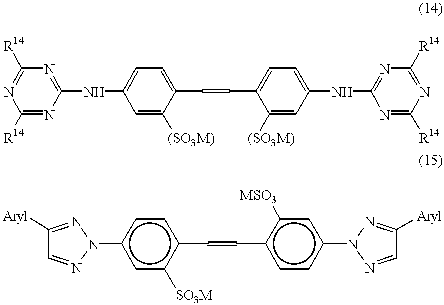

6. The method of one or more of claims 1 to 5, wherein the amount of constituent B) is 25% by weight or less of the total brightener weight.
